(19) United States
(12) Patent Application Publication
(10) Pub. No.: US 2007/0239430 A1
(43) Pub. Date: Oct. 11, 2007

(54) Correcting semantic classification of log data

(75) Inventor: David G. Ollason, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/390,578

(22) Filed: Mar. 28, 2006

(51) Int. Cl. G06F 17/27

(52) U.S. Cl. 704/9

(57) ABSTRACT

Speech log data is received, and possible semantic classifications for that log data are obtained from grammars that were active in the system when the log data was received. Audio information from the log data, along with the possible semantic values, are then presented for user selection. A user selection is received, and corrected log data is generated based on the user selected semantic value.

### BACKGROUND

Currently, applications for speech recognition systems are widely varied. Many speech recognition applications allow a user to provide a spoken input, and a speech recognition system identifies a semantic value corresponding to the spoken input. Such systems are often implemented in dialog systems which are conducted by telephone.

In a telephone-based dialog system, a user of the system calls in and provides spoken inputs which are recognized by the speech recognizer based on grammars. The speech recognition system may activate different grammars, or different portions of grammars, based on where the application is in the dialog being conducted with the user.

By way of specific example, assume that a dialog system is implemented in a pizza restaurant. The dialog system takes orders from customers that call in by telephone. The dialog system directs the user through a dialog by prompting the user with questions. The speech recognition system then attempts to identify one of a plurality of different expected semantic values based on the user's spoken input in response to the prompt.

For instance, the dialog system may first ask the user “Do you wish to order a pizza?” The speech recognition system would then be expecting the user to give one of a plurality of expected responses, such as: “yes”, “no”, “yes please”, “no thank you”, etc. Assuming that the user responds affirmatively, the dialog system may then ask the user “What size pizza would you like?” The speech recognition system might then activate a portion of the grammar looking for expected responses to that question. For instance, the speech recognition system may activate the portion of the grammar that is looking for semantic values of: “large”, “medium”, “small”, “I'd like a large please”, “Please give me a small”, etc.

One problem with these types of grammar-based systems is that it is very difficult for the developer of the system to anticipate all of the different ways that a user may respond to any given prompt. For example, if the system is expecting a response indicative of a semantic value of “large”, “medium”, or “small”, the user may instead say “family size”, or “extra large”, neither of which might be anticipated by the dialog system. Therefore, these responses may not be accommodated in the grammars currently active in the speech recognizer.

In the past, one way of tuning the grammars in these types of speech recognition applications was to listen to and manually transcribe call log data for calls that resulted in errors by the speech recognition system. For instance, the audio data corresponding to calls that ended in a hang-up, instead of an order being placed, can be used to tune the system. In using that information, the audio information for a call is first transcribed into written form. This is a laborious and time consuming process. The misrecognition originally recognized by the speech recognition system is provided to the developer, along with the transcribed audio information. The developer then either writes a new grammar rule to accommodate the unexpected response, or manually maps the transcribed data to one of the expected semantic values, and uses that mapping in revising the grammar. Of course, this is highly time consuming and costly, because the audio information not only has to be transcribed, but then the transcription must be used to modify the grammar in some way.

Another type of technology currently in use is referred to as “Wizard of Oz” technology. In this context, “Wizard of Oz” is a term used in the art to describe a method by which voice user interface applications are evaluated where the evaluation subject (the person interacting with the system) believes that he or she is talking to an automated system. In fact, however, the flow of the voice user interface application is entirely under the control of the system designer who is unseen by the evaluation subject. The system designer is presented with a user interface that allows the designer to easily (and in real time) select an appropriate system action based on the subject's input (or response to a question).

The discussion above is merely provided for general background information and is not intended to be used as an aid in determining the scope of the claimed subject matter.

### SUMMARY

Speech log data is received, and possible semantic classifications for that log data are obtained from grammars that were active in the system when the log data was received. Audio information from the log data, along with the possible semantic values, are then presented for user selection. A user selection is received, and corrected log data is generated based on the user selected semantic value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative environment in which the present subject matter can be used.

FIG. 2 is a block diagram of one illustrative correction system.

FIG. 3 is a flow diagram illustrating the operation of the correction system shown in FIG. 2.

FIG. 4 is an illustrative representation of log data.

FIGS. 5A and 5B are two illustrative screenshots showing how corrections can be made.

FIG. 6 is one exemplary illustration of corrected log data.

### DETAILED DESCRIPTION

The present subject matter deals with correcting semantic classifications for speech data that is stored in a data log. However, before describing the subject matter in more detail, one illustrative environment in which the present subject matter can be used will be described.

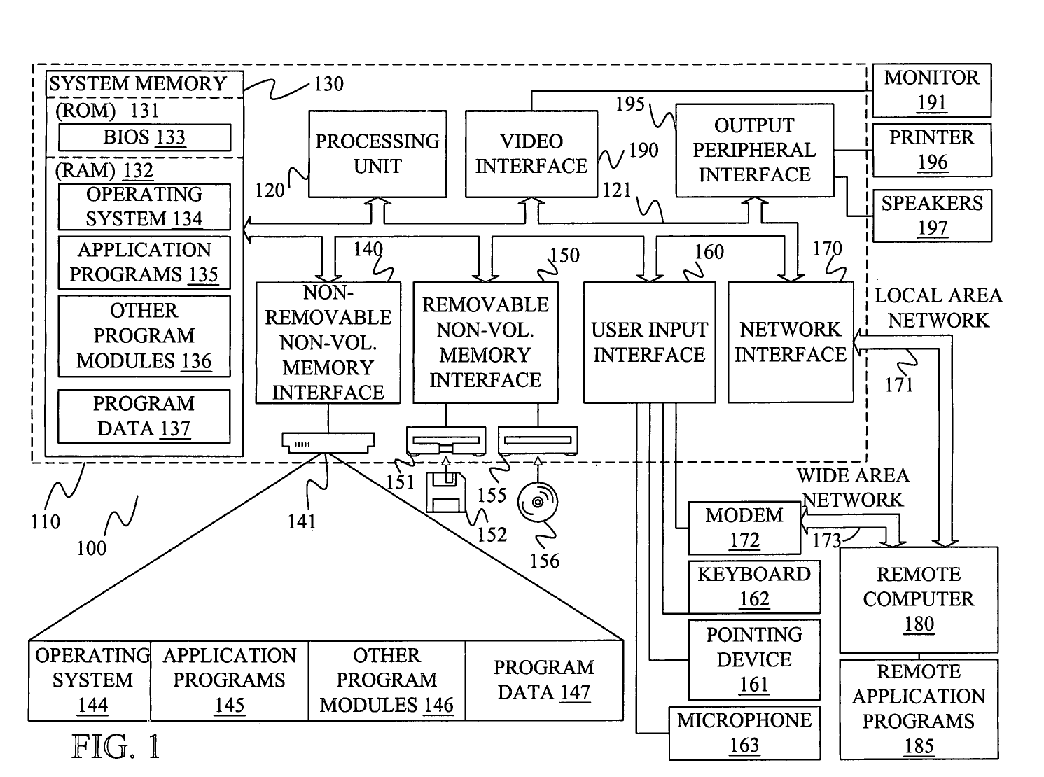

FIG. 1 illustrates an example of a suitable computing system environment 100 on which embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

While the present subject matter can be used to correct semantic values for any log data, it will be described herein in the context of correcting semantic values associated with speech inputs logged for a voice user interface in a dialog system. However, the invention is not to be so limited, and a wide variety of different speech recognition-based systems can be improved using the present subject matter.

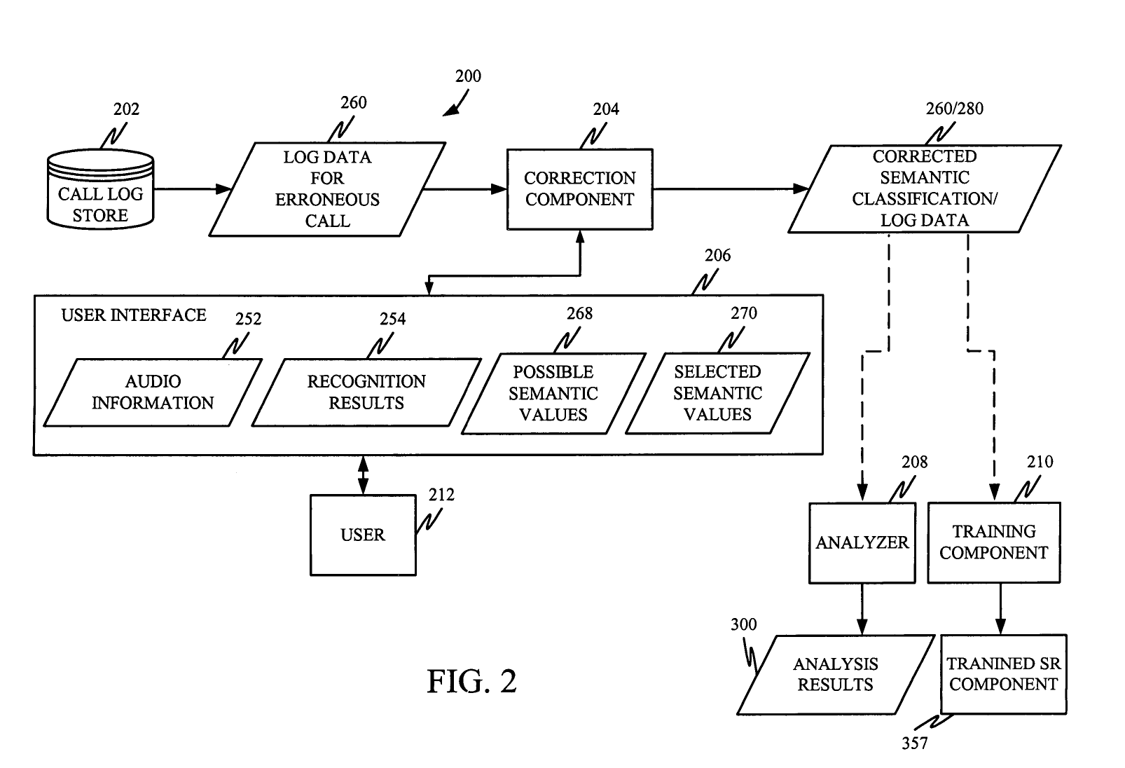

FIG. 2 is a block diagram of one illustrative correction system 200 in accordance with one embodiment. System 200 includes call log store 202, correction component 204, user interface component 206, and optional analyzer 208 and training component 210.

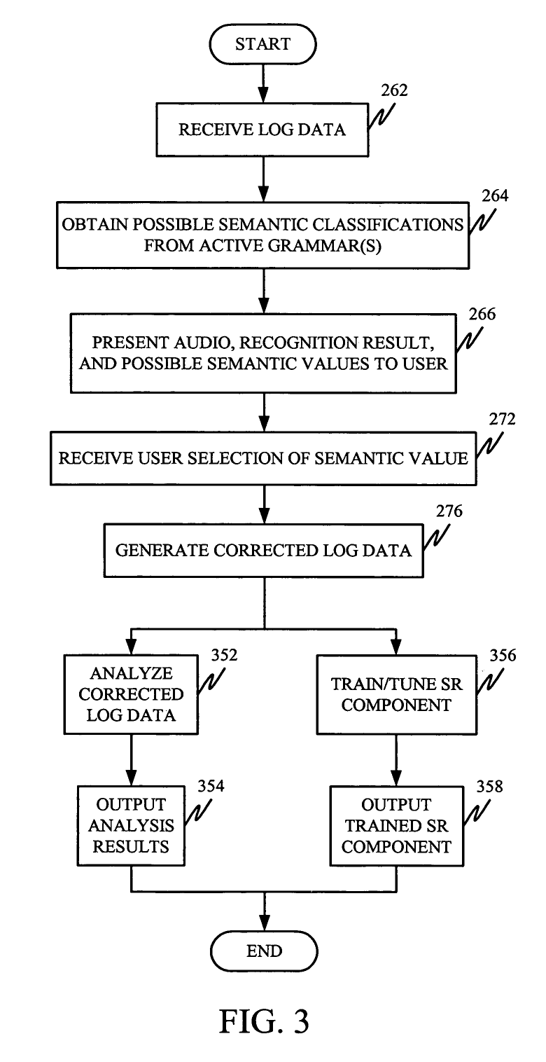

FIG. 3 is a flow diagram illustrating one embodiment of the operation of system 200 shown in FIG. 2. FIGS. 2 and 3 will be described in conjunction with one another.

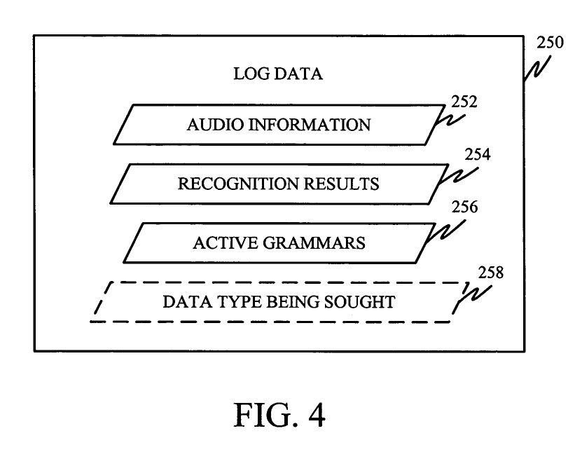

Call log store 202 illustratively stores a log of calls that were made to a dialog system, and that ended in erroneous speech recognitions of the voice data input by the customer or user of the system. While call log store 202 can store a wide variety of information, it illustratively at least stores log data for calls that were erroneously recognized. FIG. 4 is a block diagram of one illustrative embodiment of the log data stored in call log store 202. FIG. 4 shows that log data 250 illustratively includes audio information 252, recognition results 254, active grammar information 256, and optional data type information 258.

Audio information 252 is illustratively audio data that can be played back to a user 212 (shown in FIG. 2) such that the user 212 can hear what the customer said during the dialog session for which the log data was recorded. Recognition result 254 illustratively provides the recognition result that was recognized by the speech recognition system during the real time dialog session, and which resulted in an incorrect recognition.

Active grammar information 256 is illustratively one or more indicators that indicate the particular grammars, or portions of grammars, that were active in the speech recognition system during the time of the dialog session during which speech recognition result 254 was recognized. In other words, assume the dialog was asking the customer what size pizza they would like. Then active grammar information 256 will indicate that the active grammars were those grammars (or portions of grammars) that expected a speech input corresponding to semantic values that indicate pizza size.

Data type information 258 is optional, and indicates the particular data type being sought by the speech recognition system at that point in the dialog session. For instance, it may be that the dialog was seeking a name of an American city. That city may illustratively be stored on a list of American cities, and in that case, the data type being sought would be a list. This is optional and its use will be described in greater detail below.

Referring again to FIGS. 2 and 3, correction component 204 first obtains a call log record from the log data in call log data store 202. The call log record will illustratively be for an erroneous call, or one for which the speech input was misrecognized. The log data is indicated by block 260 in FIG. 2, and the step of receiving the call log data 260 is indicated by block 262 in FIG. 3.

Correction component 204 then accesses the grammars for the underlying speech recognition system and identifies, based on the active grammar information 256 (shown in FIG. 4) possible semantic classifications 268 from the grammars that were active at that point in the dialog session. Again, for example, assume that at that point in the dialog session, the dialog was asking the customer for the size of the pizza desired. In that case, correction component 204 retrieves all of the semantic values 268 that were expected in response to that dialog prompt, based upon which grammars or portions of grammars were active at that time in the session. In this example, the semantic values or classifications 268 retrieved would correspond to pizza sizes. Obtaining the possible semantic classifications 268 is indicated by block 264 in FIG. 3.

Correction component 204 then provides, through user interface 206, the audio information 252, the prior recognition result 254, and the possible semantic values 268 identified from the active grammars. This is indicated by block 266 in FIG. 3.

User 212 then actuates a mechanism on user interface 206, which can be any desired mechanism such as a radio button or other mechanism, and plays audio information 252. User 212 listens to the audio information 252 and determines which of the possible semantic values 268 the audio information should be mapped to. For instance, again assume that the possible semantic values 268 are the pizza sizes “small”, “medium”, and “large”. Each of those possible semantic values will illustratively be presented to user 212 on user interface 206 in a user-selectable way, such as in a radio button, or other user selectable input mechanism. Assume that the audio information 252 indicates that the user stated “family size”. User 212 can then select the possible semantic value 268 of “large” by simply clicking on the radio button (or other user interface element) corresponding to the semantic value of “large”. The selected semantic value 270 is then provided from user interface component 206 to correction component 204. Receiving the user selection of the semantic value is indicated by block 272 in FIG. 3.

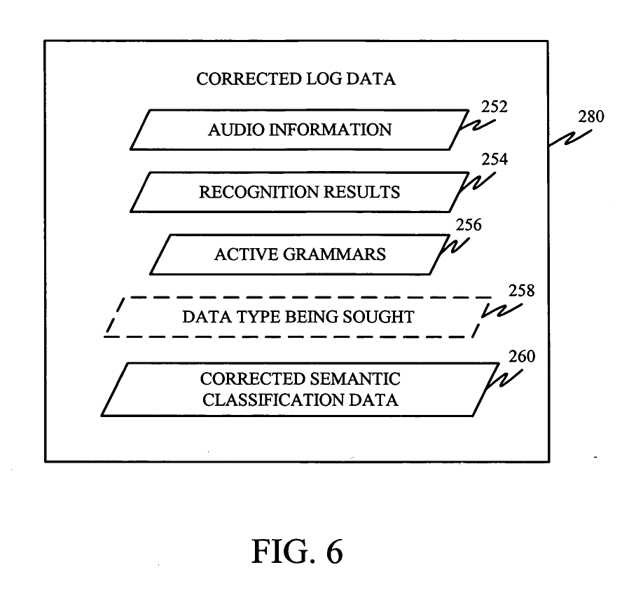

Correction component 204 then generates corrected log data 280. This is indicated by block 276 in FIG. 3. The corrected log data 280 illustratively includes corrected semantic classification data 260 which shows that the speech data represented by audio information 252 is now mapped to the selected semantic value 270. One embodiment of the corrected log data 280 is shown in FIG. 6. The corrected log data will illustratively be stored in call log store 202 as corrected log data. The corrected log data 280 may illustratively include the original audio information 252, the original speech recognition result 254, the active grammars indicator 256, the data type being sought 258 (which again is optional), as well as the corrected semantic classification data 260.

The corrected log data 280 or just the corrected semantic classification data 260 can be used in a wide variety of different ways. For instance, the data can be provided to analyzer 208 which analyzes the data to determine the semantic accuracy of the grammar or speech recognizer. Analyzer 208 can also provide a wide variety of analyses of the data, and output analysis results 300 indicative of the analysis performed by analyzer 208. Analyzing the corrected data and outputting the analysis results is indicated by blocks 352 and 354 in FIG. 3.

Corrected semantic classification data 260 (or the corrected log data 280) can also be provided to training component 210. Training component 210 can identify out-of-grammar phrases for various known semantic classes and generate rules in the grammar associated with those out-of-grammar phrases. Training component 210 can also find unknown semantic classes, such as categories that users talk about, but that are not used in the current dialog system (e.g., “extra large” pizza, in addition to small, medium and large). Component 210 can then generate rules in the grammar to accommodate those unknown semantic classes. Training component 210 can also apply machine-learning techniques to automatically update the statistical likelihood's underlying the deployed system's grammars and semantic classification techniques (including, for example, reinforcement learning on positive results) without further user intervention. Training or turning a speech recognition component (such as a grammar) is indicated by block 356, and outputting the trained component 357 is indicated by block 358.

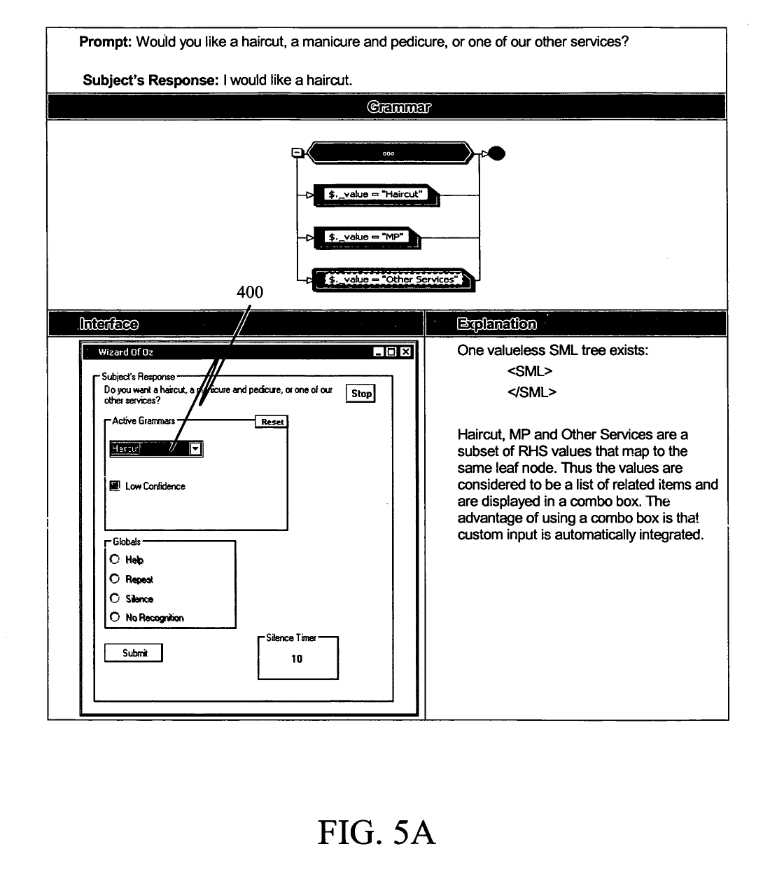

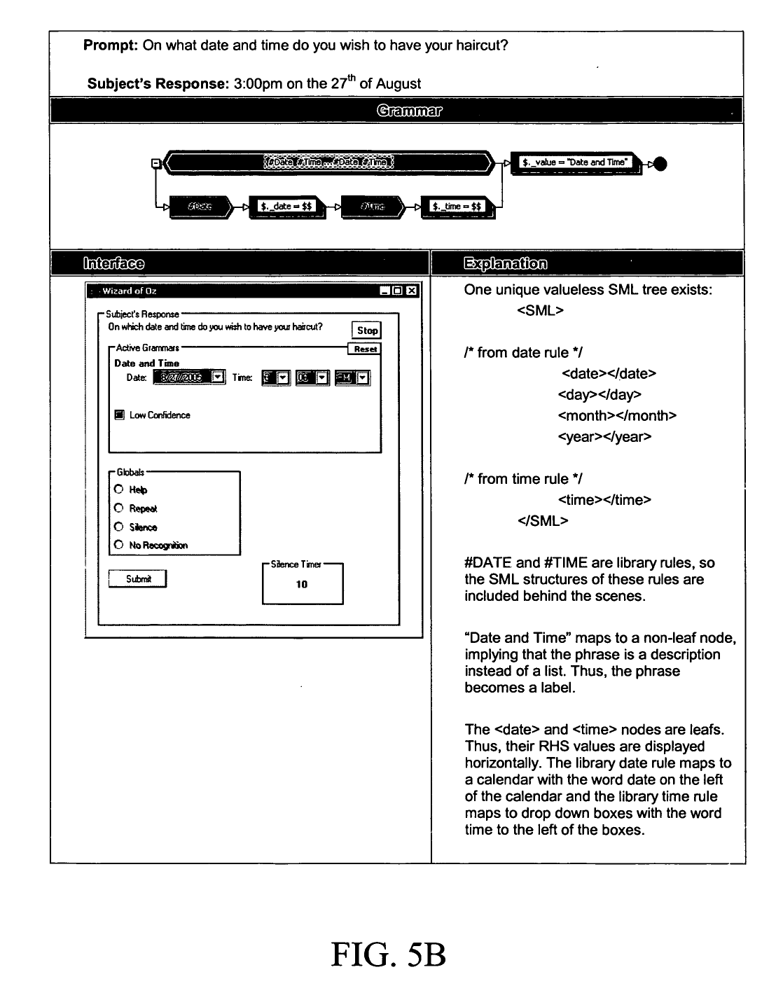

FIGS. 5A and 5B show two illustrative screenshots which can be used by user 212 to select one of the possible semantic classifications, and map it to the speech input represented by the audio information 252 that the user listens to.

FIG. 5A shows a screenshot in which the prompt to the user was “Do you want a haircut, manicure and a pedicure, or one of our other services?” The user answered “I would like a haircut” and this is displayed in dropdown box 400 as the recognized result. In the embodiment shown in FIG. 5A, the responses “haircut”, “manicure and pedicure”, and “other service” are each a subset of values that map to a same leaf node in the grammar. Thus, the values are considered to be a list of related items and are displayed in the combo box 400. Hence if, the user actuated the arrow on the right side of combo box 400, all of the possible semantic values from the active grammars would be displayed, and the user could simply select one.

FIG. 5B shows another screenshot in which the user was asked “On which date and time would do you wish to have your hair cut?” The user's response was “3 p.m. on the 27^{th} of August.” This is embodied in the audio information which is played to the person using the interface shown in FIG. 5B. In the embodiment shown, the input was recognized properly, and the speech recognition result thus displays the proper date and time fields in the active grammars shown in FIG. 5B. However, if the speech input was misrecognized, the person reclassifying the semantic label could simply actuate the arrows in the active grammar field and select a new date and time based on the audio for the speech input.

It will also be noted that if the expected data type being sought 258 is logged, and provided in log data 260, correction component 204 can use the expected data type 258 in generating a more useful user interface to be presented to user 212 by component 206. For example, assume that the dialog at the time the data was logged was looking for a date, as shown in FIG. 5B. If that data type (date) is logged, then correction component 204 can generate a calendar on user interface 206, which can be used by user 212 to simply select the date that is represented by the audio information 252. Assume, again, that the response by the user being sought is the expiration date of a credit card. This data type could easily be accommodated on the user interface by two separate dropdown boxes, one for selection of a month, and the other for selection of a year.

In one illustrative embodiment, the designer of the grammar under analysis illustratively includes in the grammar the data type being sought for each of the given grammars or grammar rules. Therefore, when log 202 logs the active grammars, it also logs the data types being sought by the active grammars. In that embodiment, correction component 204 reads the data types being sought and dynamically generates the possible semantic values 268 using user interface structures suitable to the data type being sought (such as the calendar, dropdown boxes, etc.).

It can thus be seen that the present subject matter can be used to drastically streamline the process of tuning grammars that was previously done using extremely costly and time consuming manual transcription processes. The present subject matter provides a relatively simple interface for rapidly classifying user utterances into semantic buckets. The semantic information is useful in itself for a wide variety of analytical and tuning purposes, and the analytical and tuning processes are significantly speeded up by this subject matter. In addition, the user interface used for transcription automatically presents the transcriber or user, with the set of possible semantic values, which can be read directly from the active grammars.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of correcting semantic classifications of speech data in a dialog system having a grammar, comprising:
accessing log data storing an audio representation of the speech data;
identifying possible semantic values for the speech data based on grammar rules active when the speech data was received at the dialog system;
presenting the audio representation and the possible semantic values to a user interface; and
receiving a user selection of one of the possible semantic values for the speech data.

2. The method of claim 1 and further comprising:
mapping the speech data to the selected possible semantic value to obtain a corrected semantic classification of the speech data.

3. The method of claim 2 and further comprising:
tuning a speech recognition component based on the corrected semantic classification.

4. The method of claim 3 wherein tuning a speech recognition component comprises:
tuning the grammar.

5. The method of claim 2 and further comprising:
performing and analysis of the corrected semantic classification; and
generating an analysis output indicative of the analysis of the corrected semantic classification.

6. The method of claim 1 wherein presenting comprises:
presenting the possible semantic values on a user interface, associated with a user actuable selection mechanism.

7. The method of claim 1 wherein accessing log data comprises:
accessing an active grammar indicator indicative of the grammar rules active when the speech data was received by the dialog system.

8. The method of claim 1 wherein accessing log data comprises:
accessing a data type indicator indicative of a data type being sought and presenting is based on the data type being sought when the speech data was received by the dialog system.

9. The method of claim 8 wherein presenting comprises:
presenting the possible semantic values in a form based on the data type indicator.

10. The method of claim 1 wherein presenting comprises:
presenting a semantic value assigned by the dialog system when the speech data was received by the dialog system.

11. A semantic classification system, comprising:
a data store storing audio information indicative of a speech input received by a speech related system and a semantic value indicator indicative of possible semantic values expected in the speech related system when the speech input was received;
a correction component; and
a user interface coupled to the correction component, the correction component being configured to receive the audio information and the semantic value indicator and to present to the user interface the audio information and the possible semantic values, the user interface being configured to present the audio information and possible semantic values for user selection to correct a semantic classification of the speech input.

12. The semantic classification system of claim 11 wherein the data store stores the semantic value indicator as a grammar indicator indicative of grammar rules active when the speech related system received the speech input.

13. The semantic classification system of claim 12 wherein the correction component is configured to identify the possible semantic values based on the active grammar rules.

14. The semantic classification system of claim 11 wherein the data store stores a data type indicator indicative of a data type expected by the speech related system when the speech related system received the speech input.

15. The semantic classification system of claim 14 wherein the user interface is configured to present the possible semantic values to the user with a user selection mechanism based on the data type indicator.

16. The semantic classification system of claim 11 wherein the user interface is configured to receive user selection of a possible semantic value to reclassify the speech input.

17. The semantic classification system of claim 16 and further comprising:
an analysis component configured to generate an analysis output based on the reclassified speech input.

18. The semantic classification system of claim 16 and further comprising:
a training component configured to train a speech related component based on the reclassified speech input.

19. A computer readable medium storing computer executable instructions which, when executed by a computer cause the computer to perform steps of:
receiving log data indicative of stored audio data for a speech input to a speech system and a semantic indicator indicative of expected semantic values, expected by the speech system when the speech input was received by the speech system; and
presenting the audio data and the expected semantic values, such that the expected semantic values can be selected by a user to provide a semantic classification to the speech input.

20. The computer readable medium of claim 19 wherein the semantic indicator comprises a grammar rule indicator indicative of grammar rules active in the speech system when the speech system received the speech input and wherein the steps further comprise:
identifying the expected semantic values from the active grammar rules indicated by the grammar rule indicator.
